(19) United States
(12) Patent Application Publication
(10) Pub. No.: US 2019/0026004 A1
(43) Pub. Date: Jan. 24, 2019

(54) Three Dimensional Icons for Computer Applications

(71) Applicant: Chicago Labs, LLC, Chicago, IL (US)

(72) Inventor: Eric Caen, Chicago, IL (US)

(73) Assignee: Chicago Labs, LLC

(21) Appl. No.: 16/037,105

(22) Filed: Jul. 17, 2018

Related U.S. Application Data
(60) Provisional application No. 62/533,836, filed on Jul. 18, 2017.

(51) Int. Cl. G06F 3/0481; G06F 3/0484; G06F 3/0346; G06F 3/0482

(52) U.S. Cl. CPC G06F 3/04815; G06F 3/04817; G06F 3/04845; G06F 3/0486; G06F 3/0482; G06F 2203/04802; G06F 2203/04804; G06F 3/0346

(57) ABSTRACT

The present disclosure provides a system including three-dimensional icons for computer and mobile device applications. Certain embodiments of the disclosed technology use three-dimensional application icons that can be rotated to show a user a wide assortment of information, updates, alerts, and other functions in a compact and efficient manner. Rotating an icon about an axis allows for saving viewable space in the display, wherein the icon can rotate without obscuring other images in a display such as other icons. Saving viewable space in the display allows a user to access applications and icons without having to scroll through multiple display screens. In addition, the three-dimensional application icons can include sub-objects that can be sent and communicated to others without having to open the related applications.

### CROSS-REFERENCE TO RELATED APPLICATIONS

This application incorporates by reference and claims priority to U.S. Provisional Patent Application No. 62/338,836 filed Jul. 18, 2018.

### BACKGROUND OF THE INVENTION

The present subject matter relates generally to systems and methods of providing and interacting with three-dimensional icons for applications on computing devices, particularly a mobile computing devices.

Mobile operating systems typically present application icons in a flat, two-dimensional space, in nearly the exact same manner that application icons have been presented on computing devices since the first windows based GUIs became the standard operating system. Although ubiquitous, these two-dimensional layouts leave room for improvement, particularly for hand-held devices that use touch screen displays.

For example, in hand-held devices that use touch screen displays, icon selection typically mimics using a mouse to make a selection on a PC screen. But such control of selection can be more difficult on smaller touch screens. Moreover, as the number of applications available for use on a given device continues to grow rapidly, it is increasingly difficult to provide a mobile user the ability to organize, launch, and use the applications quickly and easily while also providing a platform that enables a greater amount of information related to each of the applications to be communicated to the user. Current icons simply function to select and launch an application.

Accordingly, there is a need for systems and methods of providing and interacting with three-dimensional icons for applications on a computing device, particularly mobile computing devices, such as interactive three-dimensional icons, to provide expanded functionality within the confines of a mobile display.

### BRIEF SUMMARY OF THE INVENTION

The present disclosure provides systems and methods of providing and interacting with three-dimensional icons for applications on a computing devices, particularly mobile computing devices. Among other innovations described herein, this disclosure presents various tools and techniques for displaying and using icons to represent more information and functionality than previously possible. For instance, certain embodiments of the disclosed technology use three-dimensional icons that can be rotated to show a user a wide assortment of information, updates, and other functions in a compact and efficient manner.

In an example, traditional two-dimensional icons can transform into three-dimensional icons by a user touching the user interface (e.g., screen) with three fingers simultaneously. Of course, any number of three-dimensional activations are contemplated, including but not limited to, pressing a virtual key, selecting a three-dimensional activation application, among others. For example, the traditional two-dimensional icons can be replaced by icons having the appearance of three-dimensional icon objects. The illusion of three-dimensions can be manifested from a virtual camera that calculates and renders the screen “orthographic”, wherein one side of each of the three-dimensional icons matches the traditional face of the two-dimensional icon. In an example, when tilting the device, the virtual camera follows the gyroscopic information and rotates the view of the icons up to 45 degrees (by variably matching the angle of the device), thereby enabling the user to discover (e.g., visualize) additional visual details on the sides of the three-dimensional icons. The three-dimensional icons can revert back to two-dimensional icons by any suitable method, such as shaking the device, tapping in various methods, among others.

Once an icon is depicted in three-dimensional form, a simple touch on the icon can enlarge the three-dimensional icon and enable the user to rotate the object to visualize each face of the three-dimensional icon. The three-dimensional application icon can be continuously rotated to display other faces not currently visible, such as faces located on any number of sides, tops, bottoms, and opposite side faces of the front face. In an example, a three-dimensional application icon can include at least one three-dimensional icon object projecting from the visible face. Alternatively, or in addition to, when a specific face is selected, at least one three-dimensional application icon sub-object projects from the selected face.

In an example, an application icon may include at least two faces communicating information about the application; a first face functioning as an application identifier (e.g., the application logo currently used in typical two-dimensional systems) and a second face, for example the face opposite to the first face, that includes information about the application. For example, the information face can include the application's name, publisher, installation date, frequency of use, the amount of memory the application uses, the amount of battery power the application is using, the amount of network data the application is using, access rights granted, among others.

An advantage of the present system is by using three-dimensional icons, a user's experience is improved by requiring less user action, yet producing greater results.

A further advantage of the present system is providing icon objects that can be manipulated to provide a greater range of functionality and presentation of information, in contrast to two-dimensional icons that require forced open applications to access additional functions/information.

Another advantage of the present systems is, by using three-dimensional icons, a more efficient use of the visual space on the user interface is achieved.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of an example of a user interface depicting various two-dimensional application icons.

FIG. 2 is a schematic of an example of a user interface depicting various three-dimensional application icons.

FIG. 3 is a schematic of an example of a user interface depicting various three-dimensional application icons.

FIG. 4 is a schematic of an example of a user interface depicting various three-dimensional application icons, including an expanded view of a second face of an application icon.

FIG. 5 is a schematic of an example of a user interface depicting recent photos from the three-dimensional application photo icon.

FIG. 6 is a schematic of an example of a user interface depicting recent a selected photo from the three-dimensional application photo icon copied and moved into the Messaging application.

FIG. 7 is a schematic of an example of a user interface depicting recent a selected photo from the three-dimensional application photo icon copied and moved into the mail application.

FIG. 8 is a schematic of an example of a user interface depicting recent message, map, and photo in the three-dimensional application message icon.

### DETAILED DESCRIPTION OF THE INVENTION

The present disclosure provides a system including three-dimensional icons for computer and mobile devices. Among other innovations described herein, this disclosure presents various tools and techniques for displaying and using icons to represent more information and functionality than previously possible. For instance, certain embodiments of the disclosed technology use three-dimensional icons and/or three-dimensional icon objects that can be rotated to show a user a wide assortment of information, updates alerts, and other functions in a compact and efficient manner.

The three-dimensional icons can be rotated to show a multitude of faces. For example, the three-dimensional icon and objects can be displayed as rotating about one or more axes of rotation. Rotating an icon about an axis allows for saving viewable space in the display and the icon can rotate without obscuring other images in a display such as other icons. Saving viewable space in the display allows a user to access applications and icons without having to scroll through multiple display screens of conventional two-dimensional icons.

A face of the three-dimensional application icon can display images or graphics associated with an application to the user. An application can be a program or software installed on or available to a computing device or a program or software that provides remote access to software running remotely.

The application graphic can identify the application so that the user can view what application can be launched or expanded by the user. For example, a video application can be represented by a graphic symbol of a video camera, thereby identifying the application to the user as a video recording application. In an example, the three-dimensional application icon is not attached to a two-dimensional square background, but rather a free floating graphic symbol (e.g., video camera) on the user interface.

In general, icons are small graphic symbols (usually simple images) that denote programs, commands, data files, etc. in a graphical user interface. For example, an icon can be used to launch an application (e.g., Microsoft® Word). Icons can also be used to display content (e.g., content associated with a particular application, such as a day of the week for a calendar application, a temperature for a weather application, a stock price for a stock watching application, a score of a sporting event for a sports application, and other such content). Further, icons can be animated and dynamically updated.

Typically, one three-dimensional icon is associated with one corresponding application. However, it is contemplated that a three-dimensional icon can represent a different application on each face of the object, wherein if one face is selected, a new three-dimensional object can appear with various faces, each face devoted to a different application.

In some implementations, a three-dimensional application icon can be displayed as a cube, a tile, a cylinder, a sphere, a polygon, polyhedron, or any other geometric shape. The icon can include sides, or segments (e.g., surface segments) that correspond to panels. For example, a face of the icon can be a side or surface segment of the icon. In one example, for a cube icon that includes six sides, each of the six sides of the icon can correspond to one face. For a cylinder that includes a number of surface segments, each of the number of surface segments can be a face. Some or all of the sides or segments of an icon can be faces. In certain implementations, the number of faces that are associated with the sides of an icon can exceed the number of sides that would be available in a physical manifestation of the icon. For instance seven or more faces might be associated with a six-sided cube icon, in which case the additional faces would still be shown as being one side of a six-side cube, even though the sides exist only virtually.

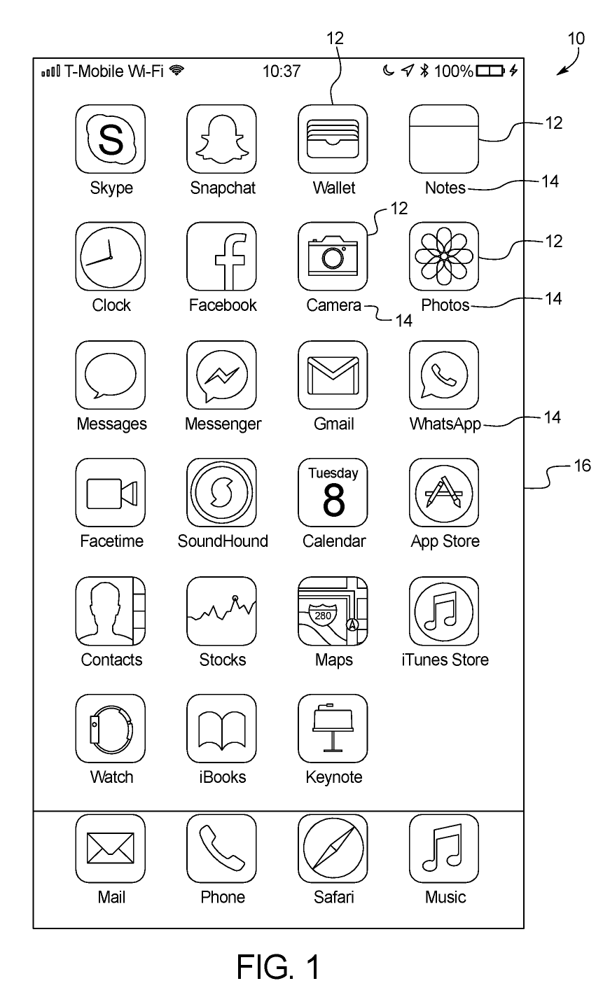

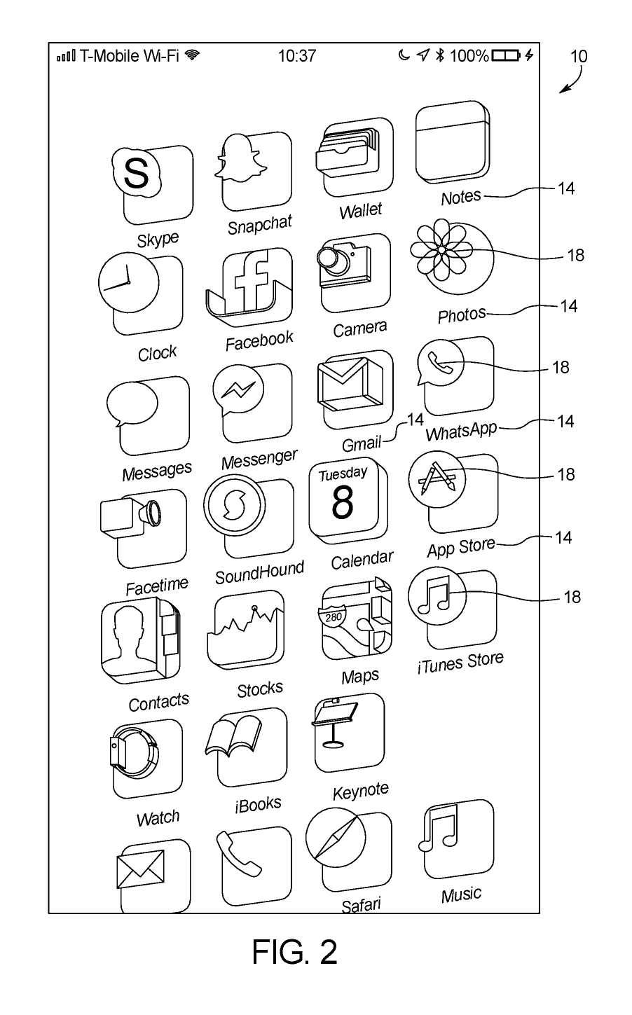

FIG. 1 is a schematic diagram of the system 10 illustrating the arrangement of two-dimensional icons 12 for a variety of applications 14 on a mobile device user interface 16. FIG. 2 is a schematic diagram illustrating the present arrangement of three-dimensional icons 18 for a variety of applications 14 on a mobile device user interface 16. In this context, the display includes a plurality of three-dimensional icons 18 representation of the two dimensional icons 12.

The three-dimensional application icon can represent a three-dimensional object 18 (e.g., a cube, a sphere, a cylinder, a polygon, a polyhedron, or any such three-dimensional object). The three-dimensional application icon 18 can project from a two-dimensional tile object. The three-dimensional application icon 18 can be rotated in three dimensions.

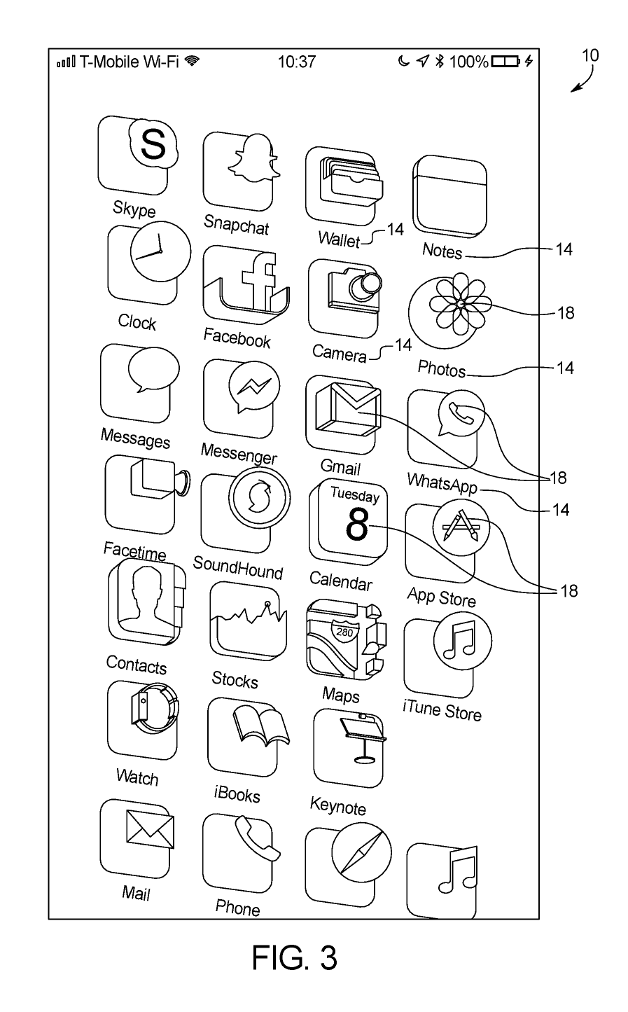

The rotation of the three-dimensional application icon 18 can refer to the appearance or representation of three-dimensional rotation on a two-dimensional display. For example, the present arrangement of three-dimensional icons for a variety of applications on a mobile device interface, however the three-dimensional projection of the three-dimensional application icons 18 can extend in different directions as shown in FIG. 2 compared to FIG. 3. In an example, the direction of three-dimensional application icons 18 projection is dependent on how the user rotates the mobile device (i.e., received gyroscope information). Alternatively, or in addition to, the direction of the three-dimensional application icons 18 projection can be manipulated by contacting the user interface 16. For example, by one finger held in place and one finger swiping in the direction of the desired direction of the projection.

In an example, traditional two-dimensional icons can transform into three-dimensional application icons by a user touching the user interface (e.g., screen) with three fingers simultaneously. Of course, any number of three-dimensional activation methods are contemplated. As previously discussed, upon activation, the traditional two-dimensional icons are replaced by optic illusion three-dimensional icon objects, as shown in FIG. 3. The illusion can be manifested from a virtual camera that calculates and renders the screen “orthographic”, wherein one side of each of the three-dimensional icons matches the traditional face of the two-dimensional icon.

In an example, as shown in FIG. 3, the two-dimensional square icon does not merely become a cube, but rather, a three-dimensional application icon 18 can be an object projected from the two-dimensional icon illustrating a depth component to the visualization of the user interface. For example, a photo application can include a three-dimensional icon object of a three-dimensional camera image projecting out from the two-dimensional icon. In some circumstances, more than one three-dimensional icon object can project from a two-dimensional icon. For example, a two-dimensional news icon application can include two to six different three-dimensional application icon sub-objects each correlating to a specific news source (e.g., CNN, Yahoo, BBC, etc.).

In an example, by tilting the mobile device the controller can follow (e.g., up to 120 items per second) and analyze the received gyroscope information and rotate up the icon 18 to 45-60 degrees on the side, matching the angle of the device, thereby enabling the user to discover (e.g., visualize) additional details on the sides of the three-dimensional application icons 18. For example, as shown in FIGS. 2-5, each figure represents various views to the user based on the tilting of the mobile device. Alternatively, or in addition to, a user can continuously spin the three-dimensional application icon 18 using the user interface (e.g., swipe action) in order to visualize the various faces of the three-dimensional application icon 18. The three-dimensional application icon 18 can revert back to two-dimensional icons 12 by any suitable method, such as shaking the device, tapping in various methods, among others.

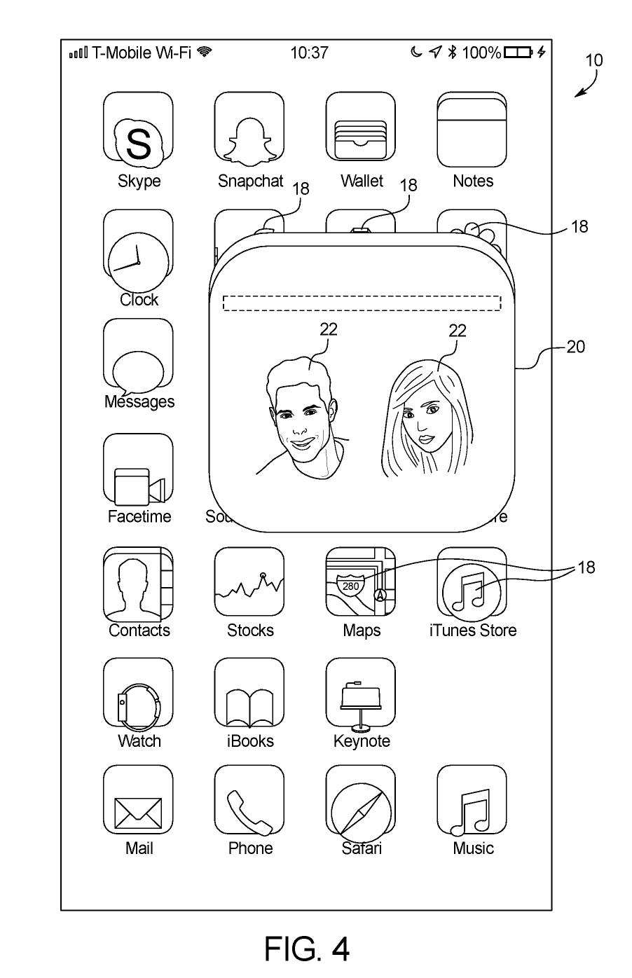

As shown in FIG. 4, a user can select a three-dimensional application icon 18 by a simple touch on the three-dimensional application icon 18, wherein selection can enlarge the three-dimensional application icon 18 into an enlarged icon 20 relative to the unselected icons and enable the user to rotate the object to visualize each face of the three-dimensional application icon. A user can rotate the enlarged icon 20 by tilting the mobile device, wherein the rotation or projection is dependent on the gyroscope data. In another example, a user may change the view of the three-dimensional application icon 18, including which of the various faces 22 appear, or control the access/view of a particular face, for example, by using the user's finger to rotate the icon or cause access to multimedia information associated therewith. For example, via a side to side sliding touch of the user's finger or other interface mechanism, such as a stylus, or other input feature or method. In some variations, the user may use an up and down motion (e.g., up and down sliding touch of the user's finger) to allow the user to view the top and/or bottom faces of the icon. Of course, other mechanisms of rotation are contemplated including, but not limited to, navigation bars, navigation menus, navigation icons, among others.

In an example, the face opposite of the identifier image face includes information about the application associated with the icon. For example, the information face 22 can include the application's name, publisher, installation date, frequency of use, the amount of memory the application uses, the amount of battery power the application is using, the amount of network data the application is using, access rights granted, among others.

Various user actions can be received based off selections on various faces of the three-dimensional application icon 18. For example, a user can select a delete option to remove the application 14 completely, a remove option to remove the application but retain the data from the application, a modify option to modify the access rights granted, among others.

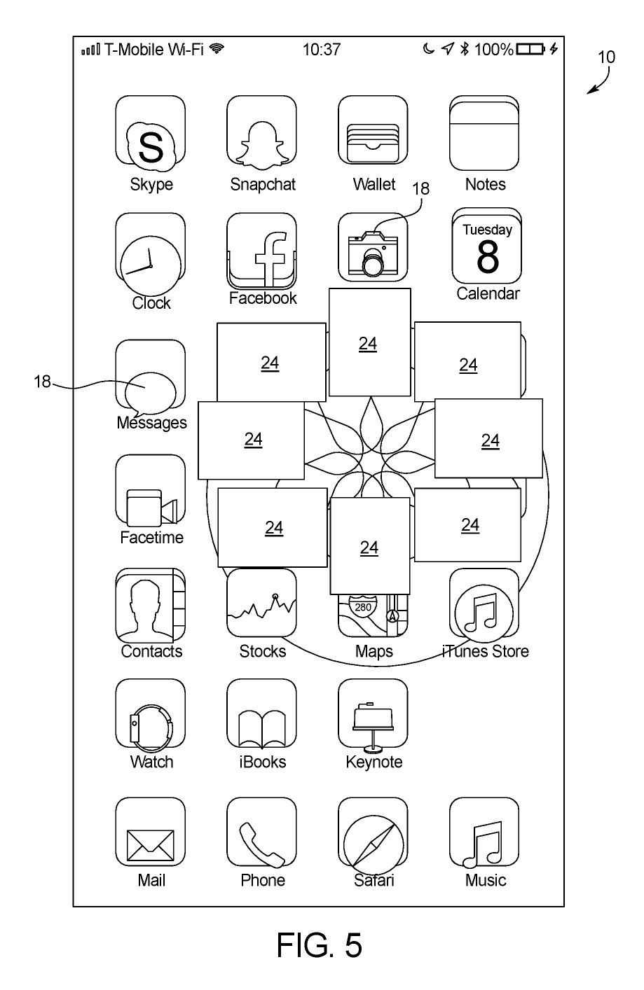

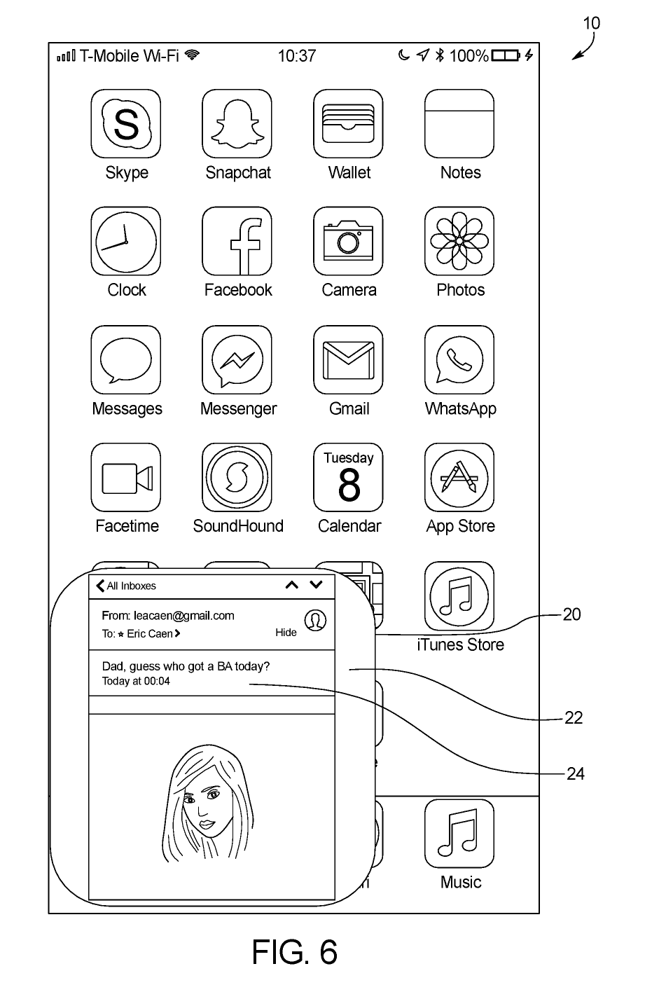

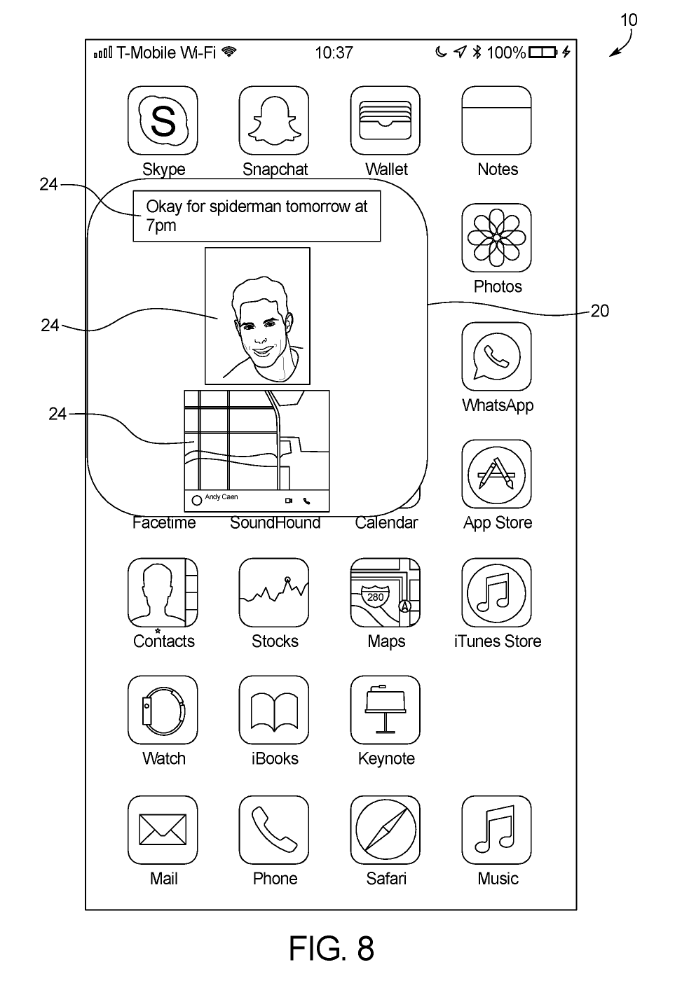

The three-dimensional application icons 18 can contain various sub-objects 24. The sub-objects can be two-dimensional or three-dimensional. In an example, in a photo application 14 the three-dimensional application icon 18 can include displaying sub-objects 24 that can relate to the latest photos, as shown in FIG. 5. In another example, in a social network application the sub-object 24 can relate to the latest messages received in the user's feed, as shown in FIG. 6, and/or in an email application the three-dimensional application icon sub-object can relate to the latest emails received. As shown in FIG. 8, the sub-object 24 could include various objects from more than one application, for example, a text message, photo, and map.

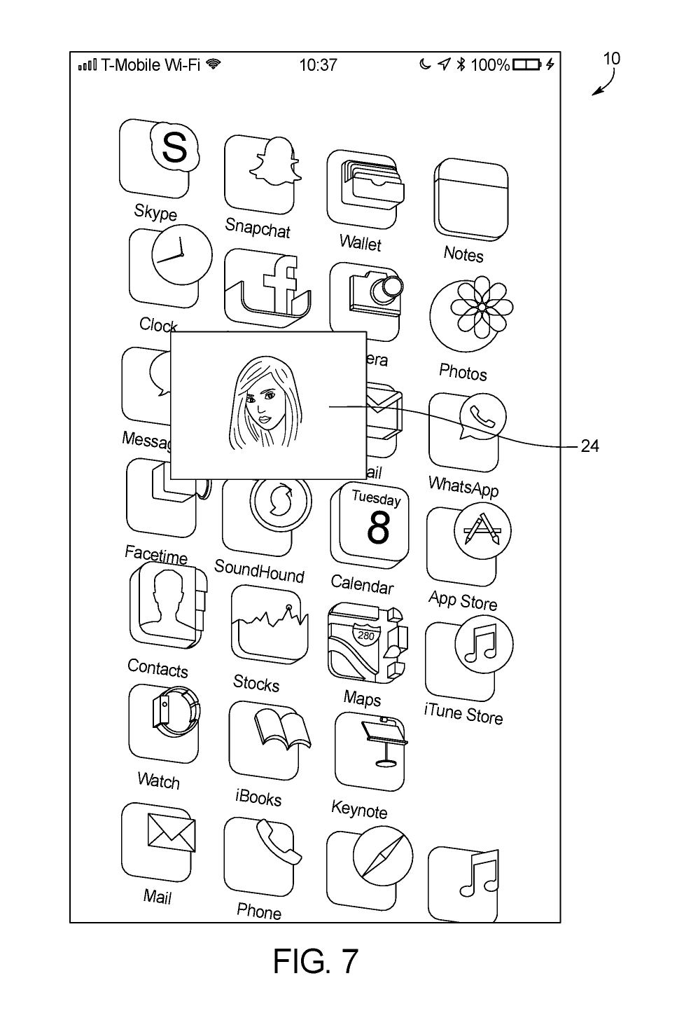

The sub-objects 24 of each application can be rotated, detached, and duplicated by touching the sub-object 24 a copy the image of the sub-object 24 can be dragged and dropped into other applications 14 visible on the user interface 16. As shown in FIG. 7, the sub-object 24 can be detached from its parent object in order to move independently and dragged over to another application 14 (e.g., a three-dimensional application icons 18).

If an application cannot receive the sub-object 24, the application can be darkened when the sub-object 24 hovers over the application that cannot receive the sub-object 24. By dropping the copy of the sub-object 24 in an application 14, a menu can appear to the user asking for further detailed instructions. For example, a photo sub-object 24 dropped on an email application 14 can prompt the system to present a question to the user as to whom the photo sub-object 24 should be sent via email.

In an example, any application 14, for example, in its three-dimensional form, receiving a notification can present an animated three-dimensional application icon 18 in order to indicate the type of information the user should know immediately, helping the user discern whether it is worth opening the application 14. For example, an email application 14 can be animated differently if the email application recognizes an email the application 14 just received is from an important sender, without opening the application 14. In an example, a banking application can indicate through a special animation whether one of the user's accounts went into overdraft status, whether the user's stock portfolio worth changed a predefined amount, and/or whether the user's account recently underwent a significant withdraw, all without opening the application 14.

Instead of the conventional view of two-dimensional icons arranged in rows and columns, the present system 10 can be implemented to include only a few three-dimensional application icons 18, each using a larger space on the screen, wherein the two-dimensional icons can appear at the top and/or under a transparent display showcasing the icons.

The system 10 includes the ability for users to expand or shrink the three-dimensional application icons 18, changing the amount of space the three-dimensional application icon 18 uses on the user interface 16. For example, the three-dimensional application icon 18 can be enlarged yet transparent to visualize the two-dimensional icons underneath the three-dimensional application icon 18. In an example, in the three-dimensional mode, a portion of the screen can be allocated to advertising, such as a three-dimensional application icon 18 devoted to various advertisements.

In addition, the user can see a different arrangement of three-dimensional application icons 18 based on the time of day or weekday versus weekend. For example, the three-dimensional application icons 18 arrangement on the user interface 16 in the morning of a working/studying day may include more applications 14 related to work communication and finances, in contrast to in the evening or over the weekend wherein the display may include more entertainment applications 14.

In an example, the system 10 enables a user to share the sub-object 24 with a friend from a user's contacts. The friend can respond by ignoring, after which the invitation can disappear after for example 10-20 seconds; reject the invitation; accept the invitation, after which a sub-object 24 can be displayed on the sender screen indicating the name of the recipient, wherein any sub-object 24 can be selected, dragged, and dropped into the three-dimensional application icon 18; or accepting to receive and share, wherein a three-dimensional application icon 18 can be displayed on the sender screen indicating the name of the recipient, wherein any sub-object 24 can be selected, dragged, and dropped into the three-dimensional application icon 18, and wherein any action on the recipient user interface can be visible to the first user.

For example, as shown in FIG. 5, the photo application 14 can include a three-dimensional sub-object 24 depicting recent photos. A user can select a photo from the three-dimensional application icon sub-object 24, copy and drop the selected photo into another application 14, such as messaging (FIG. 7) or mail applications (FIG. 6). The selection of the photo from the three-dimensional application icon 18 allows a user to quickly and efficiently detach, copy, and/or move data without having to open the photo application 14, find the photo, select the photo, copy the photo, close the photo application 14, open the mail or messaging application, and then paste the photo into the application. Further, as shown in FIG. 8, the copied photo can be dropped into the mail application 14 and emailed without opening the mail application 14. By avoiding opening various applications, the functional three-dimensional application icons 18 add a new dimension of functionality to conventional two-dimensional icons that merely identify the application 14, but provide no functionality. In fact, multiple forms of data or sub-objects 24 from more than one application can be detached, copied, and moved into another application. As shown in FIG. 8, a sub-object from a photo application, message application, and map application can be detached and moved into the message application, all without opening each parent application (i.e., photo, map, and message applications) or the message application.

Further, social media and news applications, among others, can include sub-objects 24 related to recent articles, headlines, or events. In an example, such sub-objects 24 can appear to a user in real time as an alert. The user can detach, copy, and/or drop the sub-object 24 article into any number of other applications such as message, mail, or any other social media or news application, without opening any application.

Although the present disclosure has been described with respect to examples involving three-dimensional application icons and three-dimension application icon sub-objects that are presented through the GUI of the OS. However, it is easily understood that the principles disclosed can be applied in any situation in which an icon is used, including, for example, three-dimensional icons in a social media news feed that enable a user easier access to a greater amount of information regarding a given post, photo, article, etc.

Aspects of the systems and methods described herein are controlled by one or more controllers. The one or more controllers may be adapted to run a variety of application programs, access and store data, including accessing and storing data in the associated databases, and enable one or more interactions as described herein. Typically, the controller is implemented by one or more programmable data processing devices. The hardware elements, operating systems, and programming languages of such devices are conventional in nature, and it is presumed that those skilled in the art are adequately familiar therewith.

For example, the one or more controllers may be a PC based implementation of a central control processing system utilizing a central processing unit (CPU), memory and an interconnect bus. The CPU may contain a single microprocessor, or it may contain a plurality of microprocessors for configuring the CPU as a multi-processor system. The memory may include a main memory, such as a dynamic random access memory (DRAM) and cache, as well as a read only memory, such as a PROM, EPROM, FLASH-EPROM, or the like. The system may also include any form of volatile or non-volatile memory. In operation, the memory stores at least portions of instructions for execution by the CPU and data for processing in accord with the executed instructions.

The one or more controllers may also include one or more input/output interfaces for communications with one or more processing systems. Although not shown, one or more such interfaces may enable communications via a network, e.g., to enable sending and receiving instructions electronically. The communication links may be wired or wireless.

The one or more controllers may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the one or more controllers may include a graphics subsystem to drive the output mechanism. The links of the peripherals to the system may be wired connections or use wireless communications.

Although summarized above as a PC-type implementation, those skilled in the art will recognize that the one or more controllers also encompasses systems such as host computers, servers, workstations, network terminals, and the like. Further one or more controllers may be embodied in a device, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

We claim:

1. A system comprising:
a controller;
a memory coupled to the controller, wherein the memory is configured to store program instructions executable by the controller;
wherein in response to executing the program instructions, the controller is configured to:
receive an activation user action on a user interface of a mobile device, wherein the user action indicates selection of a two-dimensional application icon;
upon receiving an activation user action, convert the two-dimensional application icon to a three-dimensional application icon;
continuously receive gyroscopic data from a gyroscope within the mobile device; and
rotate the three-dimensional application icon based on the received gyroscopic data.

2. The system of claim 1, wherein the three-dimensional application icon includes a plurality of faces, wherein the rotation of the three-dimensional application icon rotates to display one or more of the plurality of faces.

3. The system of claim 1, wherein the three-dimensional application icon includes a plurality of faces, wherein at least one face includes information about the application.

4. The system of claim 3, wherein the information is selected from at least one of publisher of the application, installation date of the application, battery usage of the application, memory usage of the application, or combinations thereof.

5. The system of claim 1, wherein the controller is further configured to receive a notification from a three-dimensional application icon, and to provide a visual alert associated with the three-dimensional application icon associated with the notification.

6. The system of claim 1, wherein upon user selection of at least one three-dimensional application icon, enlarging the selected three-dimensional application icon, wherein the enlarged three-dimensional application icon is transparent, wherein the enlarged three-dimensional application icon occupies more space on the user interface than any unselected three-dimensional application icons, wherein a user can visualize the unselected three-dimensional application icons through the selected three-dimensional application icon.

7. The system of claim 1, wherein upon user selection of at least one three-dimensional application icon, enlarging the selected three-dimensional application icon, wherein only the selected three-dimensional application icon can be rotated based on the gyroscopic data.

8. The system of claim 1, wherein upon receiving gyroscopic data indicating shaking of the mobile device, converting the three-dimensional application icon to a two-dimensional application icon.

9. The system of claim 1, wherein the three-dimensional application icon includes at least one sub-object projecting from the three-dimensional application icon.

10. The system of claim 9, wherein the controller is further configured to wherein upon receiving selection of the sub-object, copying the sub-object, and
wherein up receiving a destination selection, depositing the copied sub-object into a second three-dimensional application icon associated with the destination selection.

11. The system of claim 10, wherein receiving the destination selection includes receiving user action of dragging via the user interface the sub-object into the second three-dimensional application icon.

12. The system of claim 10, wherein depositing the copied sub-object into the second three-dimensional application icon associated with the destination selection does not open the application associated with the second three-dimensional application icon.

13. The system of claim 10, wherein upon receiving the selection of a sub-object, the controller is further configured to provide a visual menu on the user interface, wherein the menu includes a plurality of three-dimensional application icons to receive the sub-object.

14. The system of claim 9, wherein the sub-object is a photo.

15. The system of claim 9, wherein the sub-object is an email.

16. The system of claim 9, wherein the sub-object is a text message.

17. The system of claim 9, wherein the sub-object is a video.

18. The system of claim 9, wherein the sub-object is a website address.
